(19) United States
(12) Patent Application Publication
(10) Pub. No.: US 2011/0216913 A1
(43) Pub. Date: Sep. 8, 2011

(54) COMMUNICATION IMPROVEMENT IN VEHICLES

(75) Inventor: Uwe BONNE, Buettelborn (DE)

(73) Assignee: GM GLOBAL TECHNOLOGY OPERATIONS LLC, Detroit, MI (US)

(21) Appl. No.: 13/038,003

(22) Filed: Mar. 1, 2011

(30) Foreign Application Priority Data
Mar. 2, 2010 (DE) 102010009888.4

(51) Int. Cl. H04B 3/00

(52) U.S. Cl. 381/77

(57) ABSTRACT

A device for improving the communication in a motor vehicle with front and back seats includes, but is not limited to at least one first loudspeaker directed and the front seats, at least one second loudspeaker directed at the back seats, at least one first microphone directed at the front seats and an audio signal processor that can be activated in order to output speech recorded by the first microphone on the second loudspeaker. A first control element for activating the audio signal processor can be actuated from the back seats and a signal generator for displaying the activated state of the audio signal processor is visible from the front seats.

### CROSS-REFERENCE TO RELATED APPLICATION

This application claims priority to German Patent Application No. 102010009888.4, filed Mar. 2, 2010, which is incorporated herein by reference in its entirety.

### TECHNICAL FIELD

The technical field relates to a device for the improvement of the communication in a motor vehicle.

### BACKGROUND

During extended drives with the family or also on business trips, conversations are frequently held. The travelling noises however frequently make communication among vehicle occupants difficult, particularly when persons on front and back seats of a vehicle wish to communicate with one another. Certainly persons sitting next to one another can converse with normal volume and understand one another well with a normal travelling noise level, but when a person on one of the front seats wishes to ensure that he/she is well understood also by the passengers on back seats, such person as a rule has to talk unnaturally loudly and additionally attempt to turn the head to the back. The driver of the motor vehicle can therefore participate in a discussion only in a greatly limited manner without impairing the safety of the vehicle.

From DE 199 58 836 A1 a device for the communication improvement according to the preamble of claim 1 is known. In that microphones arranged in front of the front seats record remarks of the driver or of the co-driver and these being played back by loudspeakers assigned to the back seats of the vehicle, communication from the front to the back in the vehicle is facilitated. Corresponding microphones on the back seats as well as loudspeakers assigned to the front seats serve to also support the communication in the opposite direction.

A disadvantage of this known device is that the possibility for driver and co-driver to converse with each other without disturbing the passengers on the back seats or being overheard by these is lost. Although it would be conceivable to render the conventional device capable of being switched off from the front seats, this poses the problem that when one of the passengers on the back seats perceives that the system is being switched off he/she can assume that a subsequent conversation between the persons on the front seats is not intended for his/her ears, which is rather likely to even intensify his/her attention.

In view of the foregoing, at least one object is to create a device for the improvement of the communication in a motor vehicle which on the one hand permits effortless communication between passengers on front and back seats of a vehicle on the one hand and which on the other hand maintains the possibility that passengers talk to each other on the front seats of the vehicle without attracting the attention of the back passengers. In addition, other objects, desirable features and characteristics will become apparent from the subsequent summary and detailed description, and the appended claims, taken in conjunction with the accompanying drawings and this background.

### SUMMARY

A device is provided for the improvement of the communication in a motor vehicle with front and back seats, which comprises at least one first loudspeaker directed at the front seats, at least one second loudspeaker directed at the back seats, at least one first microphone directed at the front seats and an audio signal processor that can be activated in order to output speech recorded by the first microphone on the second loudspeaker, a first control element for the activating of the audio signal processor can be actuated from the back seats and a signal generator for displaying the activated state of the audio signal processor is visible from the front seats. By means of the signal generator the passengers on the front seats can evaluate at all times whether what they say can be overheard from the back, and take this into account with the content of their conversations. Thus conversations which are not meant to be overheard can be restricted to times in which the audio signal processor is not activated. Such a signal generator is practically arranged in an instrument panel of the vehicle.

A second control element making possible at least one deactivation of the audio signal processor can be assigned to the front seats. Practically, this second control element can also serve for locking the first control element so that the audio signal processor can no longer be activated from the first control element. Thus, the passengers on the front seats can protect themselves from an undesired activation of the audio signal processor, for example through children playing on the back seats.

In addition, at least one second microphone can be directed at the back seats and the audio signal processor can be equipped in the activated state to output speech recorded by the second microphone on the first loudspeaker. Since it is generally easier for a person on the front seats of the vehicle to hear conversations conducted on the back seats without technical aids then vice versa, a second such microphone according to a simplified configuration can also be omitted.

First and/or second loudspeakers are each preferentially provided in pairs and assigned to a right or left seat each. Such loudspeaker arrangements are present in many motor vehicles as output means for a car radio or the like and can be utilized within the scope of the present invention without additional costs. It is also advantageous if the first and/or second microphone is provided in pairs and in each case are assigned to a right or left seat. Thus, each individual microphone can be exactly directed at one individual person in order to capture such person's speech expressions with a minimum of background noise.

The intensity of the background noise in the passenger cell of a motor vehicle varies greatly, for example as a function of the travelling speed, the type of the road surface, the opening or closing states of windows etc. In order to make possible efficient communication regardless of the level of the background noise the audio signal processor is preferentially equipped to amplify recorded speech with a variable amplification factor as a function of the background noise.

A comparison between the signals recorded by different microphones can serve for the evaluation of the intensity of the background noise. Since the spatial distribution of the intensity of the background noise does not substantially change over the course of time the levels of the background noises recorded by different microphones have a fixed ratio to one another. When the recorded sound levels are at that ratio relative to one another it can be assumed that the recorded sound only consists of background noise and that the level of this sound level then is the dimension for the intensity of the background noise.

The audio signal processor can be equipped to deactivate itself if during a predetermined time span on at least one of the microphones no speech has been recorded. Thus it can be ensured that following an extended conversational pause in which the driver has possibly forgotten that he can be “overheard” from the back, his remarks are unintentionally perceived on the back or disturb a passenger sleeping on the back seat. A condition for an automatic deactivation can be that no speech is recorded on any of the microphones; however, it can also be sufficient that no speech is recorded only on one or a certain microphone. If for example only the absence of speech recordings on a microphone assigned to one of the back seats results in the deactivation of the audio signal processor, driver and co-driver can continuously converse without being disturbed while a passenger on the back seat can withdraw from the conversation and after some time is no longer disturbed by the continued discussion of driver and co-driver without him having to make use of the audio signal processor for this purpose.

After the audio signal processor has deactivated itself as described above it can be practically reactivatable if on the at least one microphone speech is again recorded. In this manner, a passenger on the back seat can re-join a running conversation after a period of rest, without having to access the audio signal processor. The driver is automatically informed of the fact that someone is again listening from the back since the signal generator displays the return of the audio signal processor into the activated state.

Practically the audio signal processor can be connected to at least one external audio signal source in order to output an audio signal of the external source via at least one of the loudspeakers. As external source, more preferably a radio, a mobile radio receiver, a playback device for sound carriers, a digital data carrier or a navigation device are possible. In order for the audio signal of such an external source to not impair the intelligibility of a conversation, the audio signal processor is preferentially equipped to reduce the volume of the audio signal originating from the external source on at least one of the loudspeakers while recorded speech is played back on the loudspeaker.

If as external source a navigation device is selected it can be practical, conversely, that the audio signal processor increases the volume of the audio signal originating from the external source on at least one of the loudspeakers with the simultaneous playback of recorded speech in order to ensure that a driving instruction output by the navigation device is not missed.

In addition, the audio signal processor can be connected to a mobile radio sender in order to send the speech signal recorded by the at least one first microphone or at least one of the microphones. More preferably, the audio signal processor can be part of a hands-free device for cellular mobile radio communication and the mobile radio sender can be part of a cell phone connected to the hands-free system. In that the microphone, whose recorded speech signal is fed to the mobile radio sender, is selectable, each of the vehicle occupants is enabled to conduct a conversation via mobile radio undisturbed by the other occupants.

For the mobile radio communication, one of the microphones and one of the loudspeakers each practically form a listen-speech combination. In that a first and a second such combination are each assigned different phone numbers in the mobile radio network the possibility is created to selectively call and communicate with individual occupants of the vehicle from the outside.

### BRIEF DESCRIPTION OF THE DRAWINGS

The present invention will hereinafter be described in conjunction with the following drawing figures, wherein like numerals denote like elements, and:

FIG. 1 is a block diagram of a device according to an embodiment of the invention in a motor vehicle according to a first configuration;

FIG. 2 is a block diagram of a device according to an embodiment of the invention according to a second configuration; and

FIG. 3 is a block diagram of a device according to an embodiment of the invention according to a third configuration.

### DETAILED DESCRIPTION

The following detailed description is merely exemplary in nature and is not intended to limit application and uses. Furthermore, there is no intention to be bound by any theory presented in the preceding background or summary or the following detailed description.

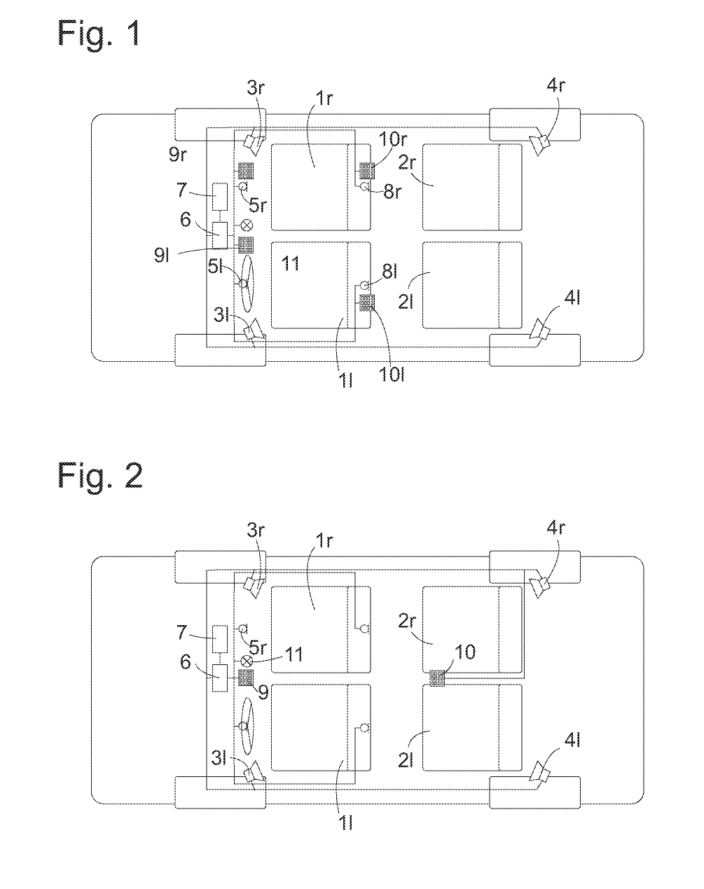

The representation of FIG. 1 shows in a schematic top view a motor vehicle with front and back seats 1l, 1r, 2l, 2r, loudspeakers 3l, 3r and 4l, 4r mounted on walls, which are not shown, of a passenger cell surrounding the seats 1l, 1r, 2l, 2r, front microphones 5l, 5r, directed at the front seats 1l, 1r, an audio signal processor 6 and an undetermined number of audio signal sources 7. In a manner known per se a car radio, a playback device for storage media such as audio cassettes, CDs, USB-sticks etc., a navigation device with speech output and the like are possible as audio signal sources 7. The audio signal processor 6 can be implemented in a common amplifier module for all audio signals sources 7; this makes possible the utilization of the loudspeakers of audio systems present in many motor vehicles also for the speech transmission between the passengers. The common amplifier module can be practically speech-controlled; a microphone required for the speech control anyway can be utilized as one of the microphones 5l, 5r.

The microphones 5l, 5r are centrally arranged in front of the seats 1l, 1r and have a bundled directivity characteristic directed at the head of the driver or co-driver in order to capture their speech expressions with a minimum of background noise. Microphones 8l, 8r directed at the back seats 2l, 2r in a similar manner can be provided, but are not absolutely essential since expressions of the passengers on the back seats 2l, 2r, if these speak facing forward, are usually adequately intelligible to driver and co-driver.

Control panels 9l, 9r, 10l, 10r for controlling functions of the audio signal processor 6 are assigned to each individual seat 1l, 1r, 2l, 2r in the configuration of FIG. 1. The front control panels 9l, 9r can more preferably be arranged in the instrument panel, the backward control panels 10l, 10r on the backs of the front seats 1l, 1r as shown in the Figure or on the insides of back doors of the passenger cell. According to a simplified version a control panel 9 each is assigned to the two front seats 1l, 1r and a back control panel 10 to both back seats 2l, 2r and accessible to passengers on both seats. As shown in FIG. 2 the front control panel 9 for example can be arranged centrally on the instrument panel and the back 10 between the seats 2l, 2r.

Each control panel 9l, 9r, 10l, 10r or 9, 10 comprises a plurality of keys as well as rotary or sliding controllers if applicable. The keys can be assigned several functions, wherein a display field, such as an LCD can be provided in each case next to multiple-assignment keys on which information relating to a function that can be accessed at a given time via a key can be displayed next to the key in ideographic form or text form.

The functions controllable with the help of the back control panels 10l, 10r or 10 include the selection of the audio signal source 7, whose signal is played back via the loudspeakers 3l, 3r, 4l, 4r, the volume of the playback, if required separately for back and front loudspeakers, functions of the selected audio signal source 7 such as the selection of a sender, if as audio signal source 7 a radio is selected, fast forward and rewind or skipping or repeating of the playback of individual recordings, if the audio signal source 7 is a playback device or a digital data carrier. In addition, the front microphones 5l, 5r can be jointly selected as audio signal source from the back control panels 10l, 10r, 10 so that conversations between driver and co-driver can be more comfortably followed and understood by the passengers on the back seats 2l, 2r, if driver and co-driver speak facing forward. Whenever the microphones 5l, 5r are selected as signal source the audio signal processor 6 activates an illuminated display 11 on the instrument panel so that driver and co-driver can always see if their conversations are clearly understood at the back or not.

The front control panels 9l, 9r or 9, like those at the back, allow the selection of the audio signal source 7 and the control of functions of the selected audio signal source. In addition, if available, a navigation device can also be selected as audio signal source via the front control panels in order to play back instructions of the navigation device regarding a route to be travelled via the front loudspeakers 3l, 3r. The navigation device can simultaneously be selected with another source 7 such as for example a radio or playback device in order to make possible a playback of the instructions simultaneously with the signal of the other source or to briefly suppress the latter signal while an instruction of the navigation device is output.

An additional function of the front control panel 9l, 9r or 9 is the disabling of the back control panels 10l, 10r or 10. If the back control panels are disabled, the audio signal processor 6 ignores inputs of the passengers on the back control panels 10l, 10r or 10 and exclusively reacts to inputs on the front control panels 9l, 9r or 9. Thus, driver and co-driver always have the possibility of determining an audio signal source 7 for output on the loudspeakers and to control this audio signal source 7. In particular, they can stop the reproduction of their conversations on the back loudspeakers 4l, 4r by selecting an audio signal source other than the microphones 5l, 5r or no audio signal source at all.

According to a further embodiment, the microphones 5l, 5r are not an audio signal source selectable as an alternative to a radio or a playback device, but they form a subsidiary signal source as described above for the navigation device, whose signal is only output simultaneously with the signal of the audio signal source 7 primarily selected or briefly in place of said signal, if a signal to the output is present, that is when it is sensed that the driver or the co-driver is talking.

In order to detect if the sound captured by one of the microphones 5l, 5r includes a speech expression or merely constitutes a travelling noise, the audio signal processor 6 continuously senses the sound level captured by the microphones 5l, 5r, and, if available, the microphones 8l, 8r. If no speech is present the recorded sound levels stand at a fixed ratio relative to one another which is dependent on the distribution of the travelling noise in the passenger cell and the arrangement of the microphones therein and, if an audio signal source 7 is in operation, on the balance setting and the volume distribution between front and back loudspeakers. If on one of the microphones 5l, 5r a sound level is received that is higher than should be expected according to this fixed distribution and if applicable the set volume, balance and distribution of the audio signal source 7, the audio signal processor 6 concludes that the driver or the co-driver is talking, cleans the audio signal recorded by the microphone 5l or 5r of a background noise calculated by means of the signals of the remaining microphones and outputs the cleaned speech signal thus obtained on the back loudspeakers 4l, 4r.

During the output of the cleaned speech signal the playback of the audio signal supplied by a simultaneously selected audio signal source 7 can be interrupted or the volume of the audio signal is temporarily reduced. Thus it is ensured that this audio signal does not impair the intelligibility of the speech; in addition the suppression or weakening of the audio signal from the source 7 simplifies the cleaning of the microphone signal.

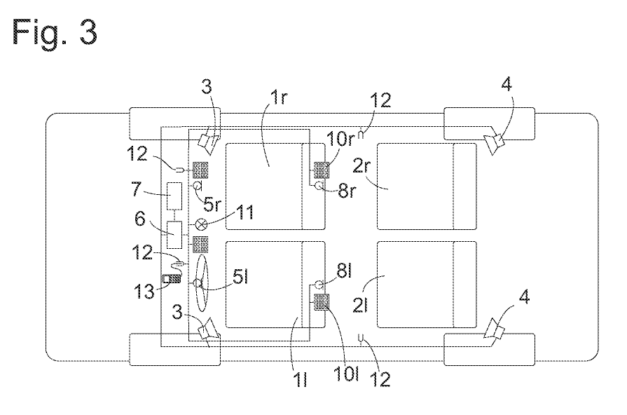

Many motor vehicles possess a hands-free system conventionally installed by the manufacturer or retrofitted which allows the vehicle occupants to telephone via a cellular mobile radio network while travelling in the car without having to hold a mobile phone to mouth and ear. Such hands-free systems have at least one microphone and if applicable filter systems in order to obtain the audio signal from an audio signal recorded by the microphone and containing speech and background noise with the background noise cleaned. The present invention can therefore be realized particularly cost-effectively if it utilizes components of such a hands-free system. A corresponding configuration of the invention is shown in FIG. 3. In addition to the components already described with reference to FIG. 1 and designated with same reference characters in FIG. 3, the device of FIG. 3 comprises a plurality of connections 12 via which in each case a cellular phone can be connected to the audio signal processor 6. In the representation of FIG. 3 each individual seat 1l, 1r, 2l, 2r is assigned such a connection 12; the number of connections however can also be fewer. Preferentially, the connections 12 are equipped with a plug connection for example according to the USB-standard which makes possible a line-based communication between the audio signal processor 6 and every connected cellular phone; a connection other than a line-connected one, for example according to the blue tooth protocol, is likewise a possibility provided a shield is present between the various connections 12 that ensures that each connection 12 only makes possible the communication with a single cellular phone neighboring on the connection 12 concerned.

If a connected cellular phone 13, for example on the connection 12 assigned to the driver's seat 11 registers an incoming call the audio signal processor 6 initially outputs an acoustic instruction in the manner known per se for hands-free systems in order to announce the arrival of the call. The output of this instruction can be effected on all loudspeakers 3l, 3r, 4l, 4r with the same volume or with the volume ratio set for the output of signals of the audio signal source 7; preferentially it is only effected on the loudspeaker located next to the connection 12, in this case the loudspeaker 3l, in order to primarily draw the attention of the person for whom the call is most probably intended. In order to accept or reject the call, the driver has to voice a corresponding command that is processed by the audio signal processor 6. It can be provided that the audio signal processor 6 only reacts to commands which are recorded by the microphone located next to the connection 12 concerned, in this case the microphone 5l. When the call is accepted the audio signal processor 6 automatically selects the called cellular phone as new audio signal source and outputs the speech signal received via the receiving part of said cellular phone on the loudspeakers 3l, 3r, 4l, 4r. The cleaned speech signal generated by the audio processor 6 from that generated by the microphone 5l is transmitted as signal to be sent via the connection 12 as signal to be sent to the cellular phone 13. Following completion of the conversation the previously active audio signal source 7 is re-activated.

Instead of outputting the incoming call on all loudspeakers it is possible according to a further developed version to merely output said call via the loudspeaker located next to the connection 12 of the called cellular phone, in this case loudspeaker 3l. The person called is able via his control panel 9l to enable the playback of the call on all loudspeakers so that all vehicle occupants can follow the call. If driver or co-driver select this option not only the speech signal of the external interlocutor but also their own speech is output via the back loudspeakers 4l, 4r. By means of the illuminated display 11 driver and co-driver can see at all times which of the two options is active. In addition to this the option of selecting a microphone other than that located next to the connection 12 of the cellular phone 13 as source for the signal to be sent can be additionally provided on the control panel 9l. It is conceivable to utilize the signals of all microphones 5l, 5r, 8l, 8r equal in rank or set an individual microphone, for example 8r, as the only source of the signal to be sent and in this way specifically pass on the call to an interlocutor desired by the caller, if the latter is not the driver. Selection options of the same type are practically not only available on the control panel 9l but also on every control panel 9l, 9r, 10l, 10r which is assigned a connection 12.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A device for improving communication in a motor vehicle with a front seat and a back seat, comprising:
a first loudspeaker directed at the front seat;
a second loudspeaker directed at the back seat;
a first microphone directed at the front seat;
an audio signal processor configured for activation in order to generate speech recorded with the first microphone on the second loudspeaker;
a first control element configured to activate the audio signal processor from the back seat; and
a signal generator configured to display an activated state of the audio signal processor that is visible from the front seat.

2. The device according to claim 1, wherein the signal generator is arranged in an instrument panel of the motor vehicle.

3. The device according to claim 1, wherein a second control element is assigned to the front seat and configured to deactivate the audio signal processor and disable the first control element.

4. The device according to claim 1, further comprising a second microphone directed at the back seat and the audio signal processor is equipped in the activated state to generate speech recorded with the second microphone on the first loudspeaker.

5. The device according to claim 1, further comprising a third loudspeaker paired with the first loudspeaker, the first loudspeaker assigned to a right and the third loudspeaker assigned to a left seat.

6. The device according to claim 1, further comprising a third microphone paired with the first microphone, the first microphone assigned to a right seat and the third microphone assigned to the left seat.

7. The device according to claim 1, wherein the audio signal processor is configured to amplify the speech with an amplification factor variable as a function of a background noise.

8. The device according to claim 1, wherein the audio signal processor is evaluate an intensity of a background noise with a comparison of signals.

9. The device according to claim 1, wherein the audio signal processor is configured to deactivate if during a predetermined time has elapsed in which no speech has been recorded.

10. The device according to claim 9, wherein the audio signal processor is configured to reactivate if following a deactivation, speech is commenced again.

11. The device according to claim 1, wherein the audio signal processor is configured for connection to an external audio signal source in order to generate an audio signal of the external audio signal source.

12. The device according to claim 11, wherein the audio signal processor is configured to reduce a volume of the audio signal originating from the external audio signal source while recorded speech is generated.

13. The device according to claim 11, wherein the external audio signal source is a radio.

14. The device according to claim 11, wherein the external audio signal source is a mobile radio receiver

15. The device according to claim 11, wherein the external audio signal source is a playback device for a sound carrier.

16. The device according to claim 11, wherein the external audio signal source is a digital data carrier.

17. The device according to claim 11, wherein the external audio signal source is a navigation device.

18. The device according to claim 11, wherein the audio signal processor is further configured to connect to a mobile radio sender in order to send the speech recorded by the first microphone.

19. The device according to claim 18, wherein the first microphone with a recorded signal fed to the mobile radio sender is selectable.
